(19) United States
(12) Patent Application Publication
(10) Pub. No.: US 2026/0091835 A1
(43) Pub. Date: Apr. 2, 2026

(54) ADJUSTABLE FORM-FACTOR TRAILER SYSTEMS AND METHODS

(71) Applicant: Torc Robotics, Inc., Blacksburg, VA (US)

(72) Inventors: William Gray Davis, Austin, TX (US); Joseph R. Fox-Rabinovitz, Austin, TX (US)

(21) Appl. No.: 18/900,152

(22) Filed: Sep. 27, 2024

(51) Int. Cl. B62D 63/06

(52) U.S. Cl. CPC B62D 63/061

(57) ABSTRACT

A trailer having an adjustable form factor is provided. The trailer includes a first box portion defining a first space and a second box portion defining a second space, wherein the first box portion is attached to the second box portion and configured to at least partially move into the second space to adjust a length of the trailer. The trailer further includes a kingpin attached to the first box portion and configured to engage a fifth wheel coupling of a vehicle and a wheel assembly attached to the second box portion.

### TECHNICAL FIELD

The field of the disclosure relates generally to vehicle trailers and, more specifically, systems and methods for adjusting a form-factor of a vehicle trailer.

### BACKGROUND OF THE INVENTION

A size of a trailer determines its legal limits on weight distribution, as well as its handling and fuel efficiency characteristics. Therefore, longer or wider trailers may be more appropriate in certain situations (e.g., with larger or heavier loads), while shorter or narrower trailers may be more appropriate in other situations (e.g., with smaller or lighter loads). Known enclosed trailers (e.g., box trailers) generally are not capable of being adjusted in size.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a trailer having an adjustable form factor is provided. The trailer includes a first box portion defining a first space and a second box portion defining a second space, wherein the first box portion is attached to the second box portion and configured to at least partially move into the second space to adjust a length of the trailer. The trailer further includes a kingpin attached to the first box portion and configured to engage a fifth wheel coupling of a vehicle and a wheel assembly attached to the second box portion.

In another aspect, a method for manufacturing a trailer having an adjustable form factor is provided. The method includes moveably attaching a first box portion defining a first space to a second box portion defining a second space, wherein the first box portion is configured to at least partially move into the second space to adjust a length of the trailer. The method further includes attaching a kingpin to the first box portion, the kingpin configured to engage a fifth wheel coupling of a vehicle, and attaching a wheel assembly to the second box portion.

In yet another aspect, a trailer having an adjustable form factor is provided. The trailer includes a bed, a roof panel supported above the bed and defining a space between the roof panel and the bed, and a first extendable box portion moveably attached to and extending laterally from the bed and the roof panel, wherein the first extendable box portion is configured to move laterally with respect to the bed and the roof panel. The trailer further includes a wheel assembly attached to the bed.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3A is a partially transparent side view of enclosed trailer having a longitudinally adjustable form factor in a shortened position;

FIG. 3B is a partially transparent side view of the enclosed trailer shown in FIG. 3A in an extended position;

FIG. 4 is a partially transparent rear view of the enclosed trailer shown in FIGS. 3A and 3B;

FIG. 5A is a partially transparent rear view of an enclosed trailer having a laterally adjustable form factor in a narrowed position;

FIG. 5B is a partially transparent rear view of the enclosed trailer shown in FIG. 5A in an extended position;

FIG. 6A is a partially transparent rear view of another enclosed trailer having a laterally adjustable form factor in a narrowed position;

FIG. 6B is a partially transparent rear view of the enclosed trailer shown in FIG. 6A in an extended position;

FIG. 7 is an example guide for use in the enclosed trailer shown in FIGS. 5A and 5B;

FIG. 8 is an example guide for use in the enclosed trailer shown in FIGS. 6A and 6B;

FIG. 9 is an example roller system for use in the guides shown in FIGS. 7 and 8;

FIG. 10A depicts another enclosed trailer having an adjustable form factor in a narrowed position;

FIG. 10B depicts the enclosed trailer shown in FIG. 10A in an extended position;

FIG. 11A depicts another enclosed trailer having an adjustable form factor in a shortened position;

FIG. 11B depicts the enclosed trailer shown in FIG. 11A in an extended position;

FIG. 12 is a flowchart depicting an example method for manufacturing the enclosed trailer show in FIGS. 3A-4;

FIG. 13 is a flowchart depicting an example method for manufacturing the enclosed trailers show in FIGS. 5A and 5B and in FIGS. 6A and 6B; and

FIG. 14 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

The embodiments described herein include enclosed trailers having an adjustable form factor. Autonomous vehicles are described herein as examples for illustration purposes only. Trailers having an adjustable form factor as described herein may be coupled with any vehicles or tractors, such as semi-tractors. In some example embodiments, an enclosed trailer is capable of being adjusted in length. In such embodiments, the enclosed trailer includes a front box portion and a rear box portion each defining an enclosed space. The front box portion is attached to a kingpin through which the enclosed trailer can be connected to a fifth-wheel coupling of a vehicle (e.g., a semi-tractor), and the rear box portion is attached to a wheel assembly to enable the enclosed trailer to move when pulled by a connected vehicle. The front box portion and rear box portion are moveably attached. Specifically, the front box portion can move telescopically into or out of the enclosed space defined by the rear portion, or in alternative configurations, the rear box portion can move telescopically into or out of the enclosed space defined by the front box portion, to shorten or extend the enclosed trailer.

In certain example embodiments, an enclosed trailer is capable of being adjusted in width. In such embodiments, the enclosed trailer includes a bed, a roof panel, and one or more extendible box portions moveably attached to the bed and the roof panel and configured to move laterally outward or inward with respect to the bed and the roof panel to adjust a width of the enclosed trailer. In some embodiments, an enclosed trailer may be both longitudinally and laterally extendable and include both the longitudinally-extendable and laterally-extendable components described herein.

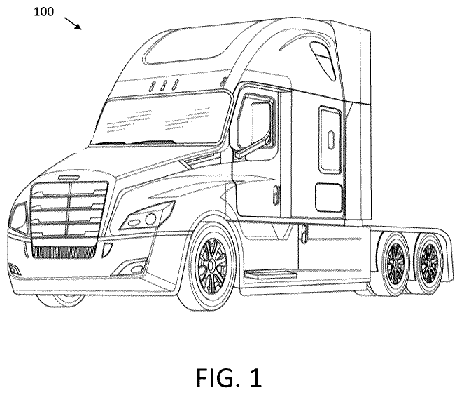

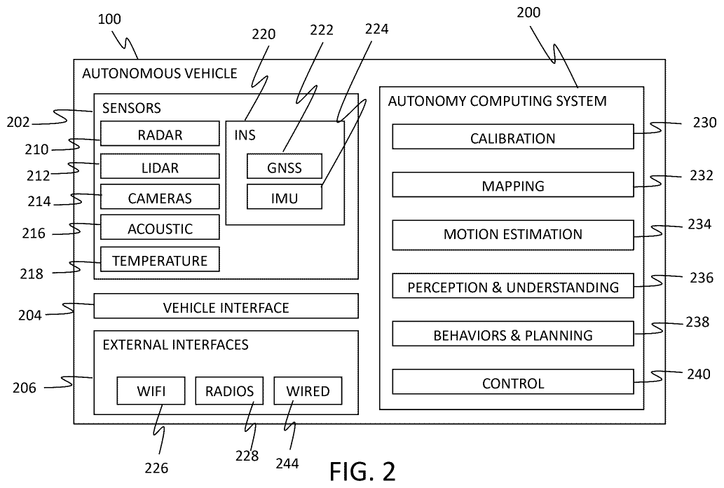

FIG. 1 is a schematic diagram of a vehicle 100. FIG. 2 is a block diagram of vehicle 100 shown in FIG. 1. In the example embodiment, vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of vehicle 100 and its proximity. As described in further detail below, these signals may be used by autonomy computing system 120 to determine how to control operation of vehicle 100.

Cameras 214 are configured to capture images of the environment surrounding vehicle 100 in any aspect or field of view (FOV). The FOV can have any angle or aspect such that images of the areas ahead of, to the side, behind, above, or below vehicle 100 may be captured. In some embodiments, the FOV may be limited to particular areas around vehicle 100 (e.g., forward of vehicle 100, to the sides of vehicle 100, etc.) or may surround 360 degrees of vehicle 100. In some embodiments, vehicle 100 includes multiple cameras 214, and the images from each of the multiple cameras 214 may be stitched or combined to generate a visual representation of the multiple cameras'FOVs, which may be used to, for example, generate a bird's eye view of the environment surrounding vehicle 100. In some embodiments, the image data generated by cameras 214 may be sent to autonomy computing system 200 or other aspects of vehicle 100, and this image data may include vehicle 100 or a generated representation of vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around vehicle 100.

GNSS receiver 222 is positioned on vehicle 100 and may be configured to determine a location of vehicle 100, which it may embody as GNSS data, as described herein. GNSS receiver 222 may be configured to receive one or more signals from a global navigation satellite system (e.g., Global Positioning System (GPS) constellation) to localize vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of vehicle 100. For example, with two GNSS receivers 222, two attitude angles (e.g., roll and yaw) may be measured or determined. In some embodiments, vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about vehicle 100 and its environment.

IMU 224 is a micro-electrical-mechanical (MEMS) device that measures and reports one or more features regarding the motion of vehicle 100, although other implementations are contemplated, such as mechanical, fiber-optic gyro (FOG), or FOG-on-chip (SiFOG) devices. IMU 224 may measure an acceleration, angular rate, and or an orientation of vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of vehicle 100.

In the example embodiment, autonomy computing system 200 employs vehicle interface 204 to send commands to the various aspects of vehicle 100 that actually control the motion of vehicle 100 (e.g., engine, throttle, steering wheel, brakes, etc.) and to receive input data from one or more sensors 202 (e.g., internal sensors). External interfaces 206 are configured to enable vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of vehicle 100 or when downloading mission data after completion of a trip. The connection(s) may be used to download and install various lines of code in the form of digital files (e.g., HD maps), executable programs (e.g., navigation programs), and other computer-readable code that may be used by vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard vehicle 100.

Autonomy computing system 200 of vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous”includes both fully autonomous and semi-autonomous.

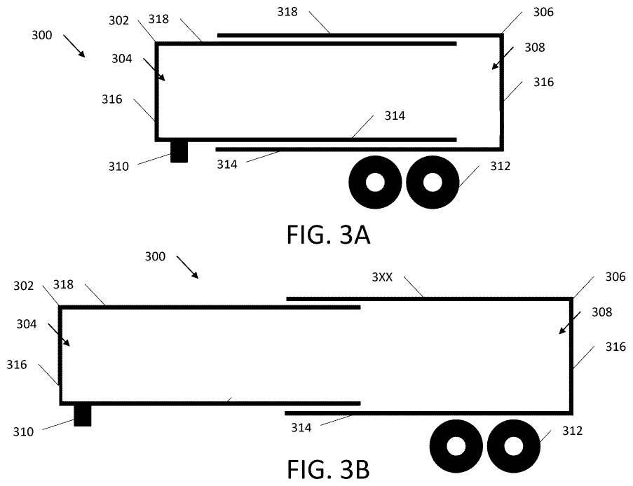

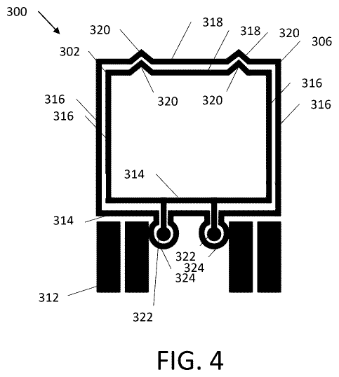

FIGS. 3A-4 depict an example enclosed trailer 300 having a longitudinally adjustable form factor. FIG. 3A is a side view of enclosed trailer 300 in a shortened position, and FIG. 3B is a side view of enclosed trailer 300 in an extended position. FIG. 4 is a rear view of enclosed trailer 300.

Enclosed trailer 300 includes a first or forward box portion 302 defining a first enclosed space 304 and a second or rear box portion 306 defining a second enclosed space 308. Enclosed trailer 300 further includes a kingpin 310 attached to first box portion 302 and configured to engage a fifth wheel coupling of vehicle 100 and a wheel assembly 312 attached to the second box portion 306.

First box portion 302 is attached to second box portion 306 and configured to move telescopically into second enclosed space 308 to adjust a length of the enclosed trailer. In other words, first box portion 302 can move telescopically into second box portion 306 to shorten enclosed trailer 300, as shown in FIG. 3A, and can move telescopically out of second box portion to lengthen or extend enclosed trailer 300, as shown in FIG. 3B. In some embodiments, first box portion 302 and/or second box portion 306 include a stop mechanism that prevents first box portion 302 and second box portion 306 from completely separating. In certain embodiments, enclosed trailer 300 includes a locking mechanism, such as one or more pins, screws, or clamps. When engaged, this locking mechanism prevents second box portion 306 from moving telescopically with respect to first box portion 302. In some such embodiments, the locking mechanism is configured to hold enclosed trailer 300 at certain predefined, standard lengths. Alternatively, the locking mechanism may be capable of holding enclosed trailer 300 at any length along a continuum from a minimum length to a maximum length. While the example embodiment shown in FIGS. 3A and 3B depict first box portion 302 as the inner portion and second box portion 306 as the outer portion, in some embodiments, the front box portion may be the outer portion and the rear box portion may be the inner portion.

First box portion 302 and second box portion 306 each include a bed 314, a set of side panels 316 attached to and vertically extending from respective side edges of bed 314, and a roof panel 318 attached to respective top edges of and extending horizontally between the set of side panels 316. In certain embodiments, enclosed trailer 300 includes a plurality of guide tracks that are disposed between the respective beds 314 of first box portion 302 and second box portion 306, between the roof panels of first box portion 302 and second box portion 306, and/or between respective side panels 316 of first box portion 302 and second box portion 306. Additionally or alternatively, in some embodiments, enclosed trailer 300 includes a plurality of rollers that are disposed between the respective beds 314 of first box portion 302 and second box portion 306, between the roof panels of first box portion 302 and second box portion 306, and/or between respective side panels 316 of first box portion 302 and second box portion 306. These guide tracks and/or rollers may reduce friction to ease movement of first box portion 302 with respect to second box portion 306. As shown in FIG. 4, in some embodiments, roof panels 318 include one or more longitudinal keels 320, with the longitudinal keels of first box portion 302 being configured to mate with and move longitudinally with respect to the longitudinal keels of second box portion 306. Longitudinal keels 320 provide additional structural support for first box portion 302 and second box portion 306.

As shown in FIG. 4, in some embodiments, first box portion 302 includes at least one first support tube 322 and second box portion 306 includes at least one second support tube 324 disposed coaxially with a respective first support tube 322. First support tubes 322 are configured to move longitudinally with respect to respective second support tubes 324, which enable first support tubes 322 and second support tubes 324 to provide structural support for enclosed trailer 300 as first box portion 302 and second box portion 306 move with respect to each other. In some such embodiments, first support tubes 322 and/or second support tubes 324 include a stop mechanism that prevents first box portion 302 and second box portion 306 from completely separating.

In some embodiments, enclosed trailer 300 may include motors or other active components for adjusting the form factor of enclosed trailer 300, which, in some embodiments, may be controlled by vehicle 100 (e.g., autonomously). Alternatively, enclosed trailer 300 may be configured to be adjusted passively. For example, if vehicle 100 is coupled to kingpin 310 of enclosed trailer 300, brakes of enclosed trailer 300 can be applied to prevent wheels of wheel assembly 312 from moving, enabling vehicle 100 to extend or shorten enclosed trailer 300 by moving forwards or backwards. In embodiments in which vehicle 100 is an autonomous vehicle, vehicle 100 can be configured to execute a routine in which vehicle 100 autonomously extends or shortens enclosed trailer 300. For example, vehicle 100 may autonomously control enclosed trailer 300 to engage its brakes and disengage any locking mechanisms between first box portion 302 and second box portion 306, move forward or backward to extend or shorten enclosed trailer 300 to a target length, and then cause the locking mechanisms between first box portion 302 and second box portion 306 to be re-engaged.

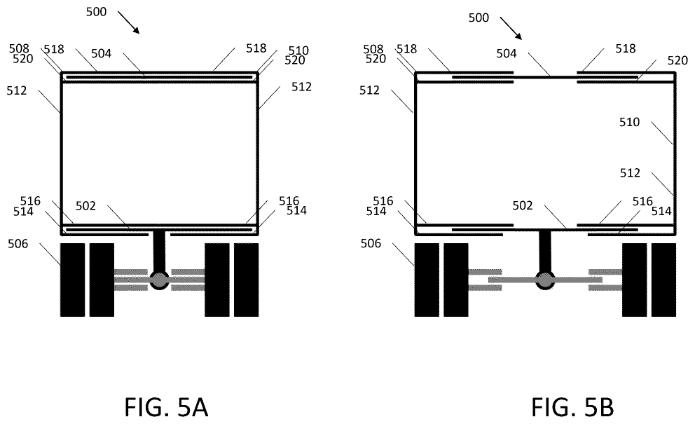

FIGS. 5A and 5B depict a rear view of an enclosed trailer 500 having a laterally adjustable form factor. FIG. 5A depicts enclosed trailer 500 in a narrowed position, and FIG. 5B depicts enclosed trailer 500 in an extended position.

Enclosed trailer 500 includes a bed 502 and a roof panel 504 supported above bed 502 and defining an enclosed space between roof panel 504 and bed 502. Enclosed trailer further includes a wheel assembly 506 attached to bed 502. Enclosed trailer 500 further includes a first extendable box portion 508 and a second extendable box portion 510 moveably attached to and extending laterally from bed 502 and roof panel 504. First extendable box portion 508 and second extendable box portion 510 are each configured to move laterally with respect to bed 502 and roof panel 504, for example, between a narrowed position as shown in FIG. 5A and an extended or widened position as shown in FIG. 5B.

First extendable box portion 508 and second extendable box portion 510 each include a side panel 512. First extendable box portion 508 and second extendable box portion 510 each further include a first lower panel 514 extending at a non-zero angle (e.g., horizontally) from a lower edge of side panel 512 and a second lower panel 516 extending at a non-zero angle (e.g., horizontally) from side panel 512 slightly above first lower panel 514, and each further include a first upper panel 518 extending at a non-zero angle (e.g., horizontally) from an upper edge of side panel 512 and a second upper panel 520 extending at a non-zero angle (e.g., horizontally) from side panel 512 slightly below first upper panel 518. First lower panel 514 and second lower panel 516 are configured to partially receive bed 502 therebetween, and first upper panel 518 and second upper panel 520 are configured to partially receive roof panel 504 therebetween. As described in further detail below, enclosed trailer 500 may further include a track mechanism to ease movement of first extendable box portion 508 and second extendable box portion 510 with respect to bed 502 and roof panel 504.

In some embodiments, wheel assembly 506 is configured to extend laterally. For example, FIG. 5A shows wheel assembly 506 in a shortened position, and FIG. 5B shows wheel assembly 506 in an extended position with a greater distance between opposite-side wheels. Wheel assembly 506 may be extended when enclosed trailer 500 is in the extended position to provide additional stability and/or clearance for first extendable box portion 508 and second extendable box portion 510 to move. In some such embodiments, wheel assembly 506 includes adjustable-length axles, which may include, for example, a hollow non-circular outer axle with a tight-fitting inner axle of complementary shape.

In some embodiments, enclosed trailer 500 may include motors or other active components for adjusting its form factor, which, in some embodiments, may be controlled by vehicle 100 (e.g., autonomously). Alternatively, enclosed trailer 500 may be configured to be adjusted passively and/or utilizing mechanical power provided through motion (e.g., forward or backward motion) of a vehicle such as vehicle 100 coupled to enclosed trailer 500.

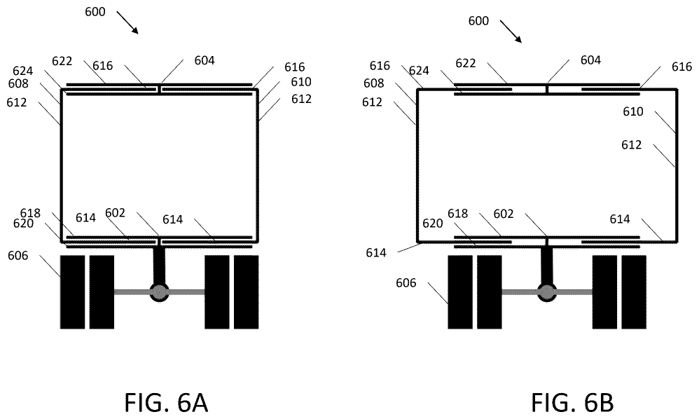

FIGS. 6A and 6B depict a rear view of an enclosed trailer 600 having a laterally adjustable form factor. FIG. 6A depicts enclosed trailer 600 in a narrowed position, and FIG. 6B depicts enclosed trailer 600 in an extended position.

Similar to enclosed trailer 500, enclosed trailer 600 includes a bed 602 and a roof panel 604 supported above bed 602 and defining an enclosed space between roof panel 604 and bed 602. Enclosed trailer further includes a wheel assembly 606 attached to bed 602. Enclosed trailer 600 further includes a first extendable box portion 608 and a second extendable box portion 610 moveably attached to and extending laterally from bed 602 and roof panel 604. First extendable box portion 608 and second extendable box portion 610 are each configured to move laterally with respect to bed 602 and roof panel 604, for example, between a narrowed position as shown in FIG. 6A and an extended or widened position as shown in FIG. 6B.

First extendable box portion 608 and second extendable box portion 610 each include a side panel 612, a lower panel 614 extending at a non-zero angle (e.g., horizontally) from a lower edge of side panel 612, and an upper panel 616 extending at a non-zero angle (e.g., horizontally) from an upper edge of side panel 612. Bed 602 includes an upper bed layer 618 and a lower bed layer 620 configured to at least partially receive lower panels 614 therebetween, and roof panel 604 includes an upper roof layer 622 and a lower roof layer 624 configured to at least partially receive upper panels 616 therebetween. As described in further detail below, enclosed trailer 600 may further include a track mechanism to ease movement of first extendable box portion 608 and second extendable box portion 610 with respect to bed 602 and roof panel 604.

In some embodiments, enclosed trailer 600 may include motors or other active components for adjusting its form factor, which, in some embodiments, may be controlled by vehicle 100 (e.g., autonomously). Alternatively, enclosed trailer 600 may be configured to be adjusted passively and/or utilizing mechanical power provided through motion (e.g., forward or backward motion) of a vehicle such as vehicle 100 coupled to enclosed trailer 500.

Both enclosed trailer 500 and enclosed trailer 600 are capable of adjusting a form factor laterally, and differ in which portions of the trailer bed and roof move during widening and narrowing. For example, when enclosed trailer 500 is moved from the narrowed to extended position, the top most layer of the floor (second lower panels 516) moves with first extendible box portion 508 and second extendible box portion 510, resulting in any objects present in enclosed trailer 500 also moving with first extendible box portion 508 and second extendible box portion 510. In contrast, when enclosed trailer 600 is moved from the narrowed to extended position, the top most layer of the floor (bed upper bed layer 618) remains stationary, so objects present in enclosed trailer 600 do not move.

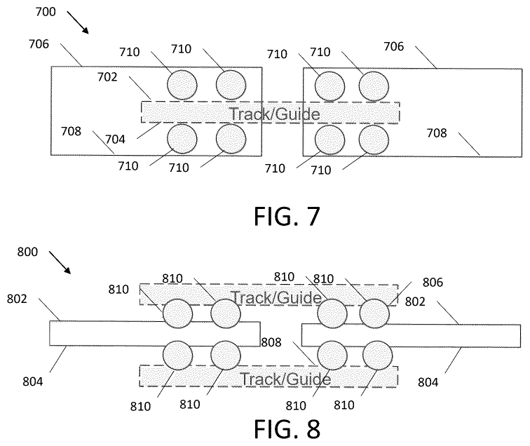

FIG. 7 depicts an example guide 700 for use in an enclosed trailer having a laterally adjustable form factor such as enclosed trailer 500. Guide 700 includes a set of inner tracks, including an upper inner track 702 and a lower inner track 704, which may be disposed, for example, on bed 502 or roof panel 504 of enclosed trailer 500. Guide 700 includes a set of outer tracks, including upper outer tracks 706 and lower outer tracks 708, which may be disposed respectively, for example, on first lower panels 514 and second lower panels 516 or on first upper panels 518 or second upper panels 520. Guide 700 further includes a plurality of wheels 710 disposed between upper inner track 702 and upper outer track 706 and between lower inner track 704 and lower outer track 708, enabling the inner tracks to move with respect to the outer tracks. Accordingly, guide 700, when installed in enclosed trailer 500, eases movement of first extendible box portion 508 and second extendible box portion 510 with respect to bed 502 and roof panel 504.

FIG. 8 depicts an example guide 800 for use in an enclosed trailer having a laterally adjustable form factor such as enclosed trailer 600. Guide 800 includes a set of inner tracks, including upper inner tracks 802 and lower inner tracks 804, which may be disposed, for example, on lower panels 614 or upper panels 616. Guide 800 further includes a plurality of outer tracks, including an upper outer track 806 and a lower outer track 808, which may be disposed respectively, for example, on upper bed layer 618 and lower bed layer 620 or on upper roof layer 622 and lower roof layer 624. Guide 800 further includes a plurality of wheels 810 disposed between upper inner track 802 and upper outer track 806 and between lower inner track 804 and lower outer track 808, enabling the inner tracks to move with respect to the outer tracks. Accordingly, guide 800, when installed in enclosed trailer 600, eases movement of first extendible box portion 608 and second extendible box portion 610 with respect to bed 602 and roof panel 604.

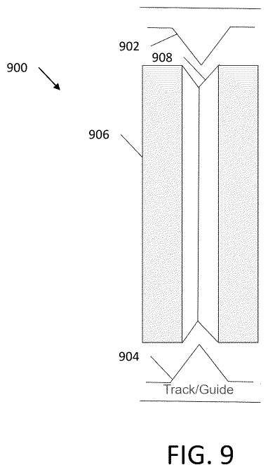

FIG. 9 depicts example roller system 900, which may be used in guide 700 shown in FIG. 7 or guide 800 shown in FIG. 8. Roller system 900 includes an upper track 902 and a lower track 904, which may correspond to any of the opposing (e.g., inner versus outer) sets of tracks described with respect to guide 700 and guide 800. Roller system 900 further includes a wheel 906, which may be an example implementation of wheel 710 or wheel 810. Wheel 906 includes a groove 908 shaped to receive upper track 902 and lower track 904, which holds wheel 906 in position as wheel 906 rolls along upper track 902 and lower track 904. While groove 908 is depicted in FIG. 9 as vee-shaped, it should be appreciated that other shapes of groove 908 and complementary shapes of upper track 902 and lower track 904 may be utilized.

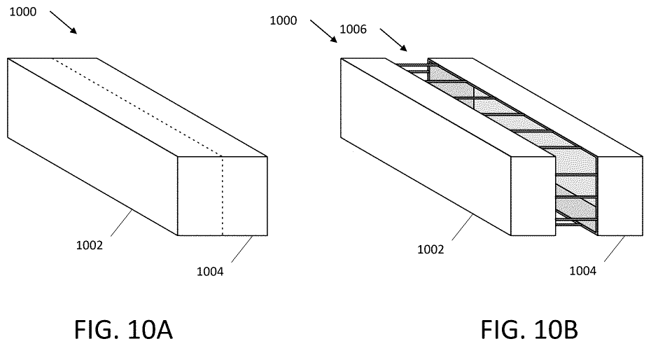

FIGS. 10A and 10B depict another example enclosed trailer 1000 having an adjustable form factor in a lateral direction. FIG. 10A depicts enclosed trailer 1000 in a narrowed position, and FIG. 10B depicts enclosed trailer 1000 in an extended position. Enclosed trailer 1000 includes a first box portion 1002 and a second box portion 1004 that define an enclosed space. First box portion 1002 and second box portion 1004 may be spread apart to expand this space. A plurality of rods 1006 connect first box portion 1002 and second box portion 1004 and may slide or move relative to first box portion 1002 and a second box portion 1004 to enable lateral movement of first box portion 1002 and second box portion 1004. For example, rods 1006 may be movably or slidably connected to one or both of first box portion 1002 and a second box portion 1004. In some embodiments, enclosed trailer 1000 includes a mesh or other flexible covering (not shown) that at least partially covers a gap between first box portion 1002 and second box portion 1004 when enclosed trailer 1000 is in the extended position. In some embodiments, enclosed trailer 1000 may include motors or other active components for adjusting its form factor. Alternatively, enclosed trailer 1000 may be configured to be adjusted passively.

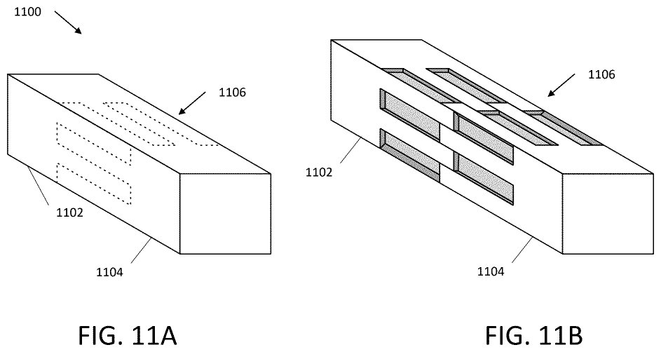

FIGS. 11A and 11B depict another example enclosed trailer 1100 having an adjustable form factor in a longitudinal direction. FIG. 11A depicts enclosed trailer 1100 in a closed or shortened position, and FIG. 11B depicts enclosed trailer 1100 in an open or extended position. Enclosed trailer 1100 includes a first box portion 1102 and a second box portion 1104 defining an enclosed space. First box portion 1102 and second box portion 1104 may be spread apart to expand this space. First box portion 1102 and second box portion 1104 each include plurality of fingers 1106 that fit together when enclosed trailer 1100 is in the shortened position. In certain embodiments, tracks, wheels, or other mechanisms for reducing friction may be present between adjacent fingers 1106. In some embodiments, enclosed trailer 1100 includes a mesh or other flexible covering (not shown) that at least partially covers a gap between first box portion 1102 and second box portion 1104 when enclosed trailer 1100 is in the extended position. In some embodiments, enclosed trailer 1100 may include motors or other active components for adjusting its form factor. Alternatively, enclosed trailer 1100 may be configured to be adjusted passively.

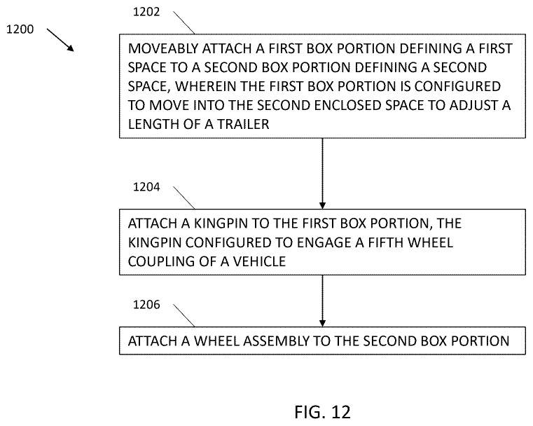

FIG. 12 is a flowchart depicting an example method 1200 for manufacturing a trailer having an adjustable form factor such as enclosed trailer 300 (shown in FIG. 3). Method 1200 includes moveably attaching 1202 a first box portion (such as first box portion 302) defining a first space (such as first enclosed space 304) to a second box portion (such as second box portion 306) defining a second space (such as second enclosed space 308), wherein the first box portion is configured to move (e.g., telescopically) into the second space to adjust a length of the trailer. Method 1200 further includes attaching 1204 a kingpin (such as kingpin 310) to the first box portion. The kingpin is configured to engage a fifth wheel coupling of a vehicle (such as vehicle 100). Method 1200 further includes attaching 1206 a wheel assembly to the second box portion.

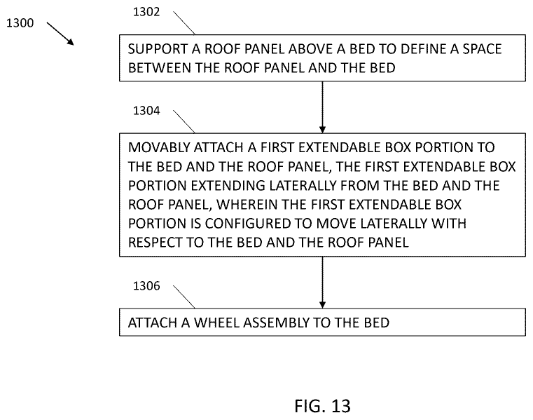

FIG. 13 is a flowchart depicting an example method 1300 for manufacturing a trailer having an adjustable form factor such as enclosed trailer 500 (shown in FIG. 5) or enclosed trailer 600 (shown in FIG. 6). Method 1300 includes supporting 1302 a roof panel (such as roof panel 504 or roof panel 604) above a bed to define a space between the roof panel and the bed. Method 1300 further includes movably attaching 1304 a first extendable box portion (such as first extendable box portion 508) to the bed and the roof panel. The first extendable box portion extends laterally from the bed and the roof panel, wherein the first extendable box portion is configured to move laterally with respect to the bed and the roof panel. Method 1300 further includes attaching 1306 a wheel assembly to the bed.

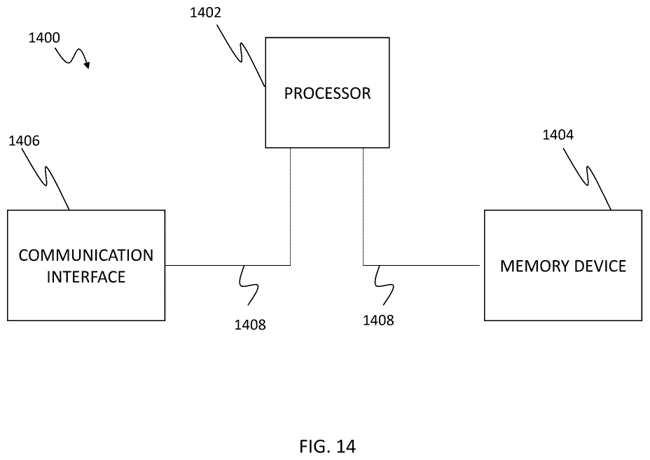

FIG. 14 is a block diagram of an example computing device 1400. Computing device 1400 includes a processor 1402 and a memory device 1404. The processor 1402 is coupled to the memory device 1404 via a system bus 1408. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 1404 includes one or more devices that enable information, such as executable instructions or other data (e.g., sensor data), to be stored and retrieved. Moreover, the memory device 1404 includes one or more computer readable media, such as, without limitation, dynamic random access memory (DRAM), static random access memory (SRAM), a solid state disk, or a hard disk. In the example embodiment, the memory device 1404 stores, without limitation, application source code, application object code, configuration data, additional input events, application states, assertion statements, validation results, or any other type of data. The computing device 1400, in the example embodiment, may also include a communication interface 1406 that is coupled to the processor 1402 via system bus 1408. Moreover, the communication interface 1406 is communicatively coupled to data acquisition devices.

In the example embodiment, processor 1402 may be programmed by encoding an operation using one or more executable instructions and providing the executable instructions in the memory device 1404. In the example embodiment, the processor 1402 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) longitudinally adjusting a form factor of an enclosed trailer by moving a first box portion telescopically with respect to a second box portion or (b) laterally adjusting a form factor of an enclosed trailer by moving an extendable box portion laterally with respect to a bed and roof panel of the enclosed trailer.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A trailer having an adjustable form factor, the trailer comprising:
a first box portion defining a first space;
a second box portion defining a second space, wherein the first box portion is attached to the second box portion and configured to at least partially move into the second space to adjust a length of the trailer;
a kingpin attached to the first box portion and configured to engage a fifth wheel coupling of a vehicle; and
a wheel assembly attached to the second box portion.

2. The trailer of claim 1, wherein the first box portion and the second box portion each comprise:
a bed;
a set of side panels attached to and vertically extending from respective side edges of the bed; and
a roof panel attached to respective top edges of and extending horizontally between the set of side panels.

3. The trailer of claim 2, wherein the roof panel of the first box portion comprises at least one first longitudinal keel and the roof panel of the second box portion comprises at least one second longitudinal keel, wherein the at least one first longitudinal keel is configured to mate with and move longitudinally with respect to the at least one second longitudinal keel.

4. The trailer of claim 1, wherein the first box portion is configured to at least partially move telescopically into the second space.

5. The trailer of claim 1, wherein the first box portion comprises a first plurality of fingers and the second box portion comprises a second plurality of fingers, the first plurality of fingers configured to engage with the second plurality of figures when the first box portion is moved into the second space.

6. The trailer of claim 1, wherein the first box portion and the second box portion together define an enclosed space.

7. The trailer of claim 1, wherein the first box portion comprises at least one first support tube and the second box portion comprises at least one second support tube disposed coaxially with the at least one first support tube, the at least one first support tube configured to move longitudinally with respect to the at least one second support tube.

8. A method for manufacturing a trailer having an adjustable form factor, the method comprising
moveably attaching a first box portion defining a first space to a second box portion defining a second space, wherein the first box portion is configured to at least partially move into the second space to adjust a length of the trailer;
attaching a kingpin to the first box portion, the kingpin configured to engage a fifth wheel coupling of a vehicle; and
attaching a wheel assembly to the second box portion.

9. The method of claim 8, wherein the first box portion is configured to at least partially move telescopically into the second space.

10. A trailer having an adjustable form factor, the trailer comprising:
a bed;
a roof panel supported above the bed and defining a space between the roof panel and the bed;
a first extendable box portion moveably attached to and extending laterally from the bed and the roof panel, wherein the first extendable box portion is configured to move laterally with respect to the bed and the roof panel; and
a wheel assembly attached to the bed.

11. The trailer of claim 10, further comprising a second extendable box portion moveably attached to and extending laterally from the bed and the roof panel opposite the first extendable box portion, wherein the second extendable box portion is configured to move laterally with respect to the bed and the roof panel.

12. The trailer of claim 11, further comprising one or more rods attached to the first extendable box portion and the second extendable box portion, wherein the one or more rods are moveably attached to one or both of the first extendable box portion and the second extendable box portion.

13. The trailer of claim 10, wherein the first extendable box portion comprises a side panel and a first lower panel and a second lower panel extending at a non-zero angle from the side panel, and wherein the first lower panel and the second lower panel are configured to partially receive the bed therebetween.

14. The trailer of claim 13, wherein the first lower panel and the second lower panel comprise one or more outer tracks, and wherein the bed comprises one or more inner tracks aligned with the one or more outer tracks, wherein one or more rollers are positioned between the one or more inner tracks and the one or more outer tracks.

15. The trailer of claim 10, wherein the first extendable box portion comprises a side panel and a first upper panel and a second upper panel extending at a non-zero angle from the side panel, and wherein the first upper panel and the second upper panel are configured to partially receive the roof panel therebetween.

16. The trailer of claim 15, wherein the first upper panel and the second upper panel comprise one or more outer tracks, and wherein the roof panel comprises one or more inner tracks aligned with the one or more outer tracks, wherein one or more rollers are positioned between the one or more inner tracks and the one or more outer tracks.

17. The trailer of claim 10, wherein the first extendable box portion comprises a side panel and a lower panel extending at a non-zero angle from the side panel, and wherein the bed comprises an upper bed layer and a lower bed layer configured to at least partially receive the lower panel therebetween.

18. The trailer of claim 17, wherein the upper bed layer and the lower bed layer comprise one or more outer tracks, and wherein the lower panel comprises one or more inner tracks aligned with the one or more outer tracks, wherein one or more rollers are positioned between the one or more inner tracks and the one or more outer tracks.

19. The trailer of claim 10, wherein the first extendable box portion comprises a side panel and an upper panel extending at a non-zero angle from the side panel, and wherein the roof panel comprises an upper roof layer and a lower roof layer configured to at least partially receive the upper panel therebetween.

20. The trailer of claim 19, wherein the upper roof layer and the lower roof layer comprise one or more outer tracks, and wherein the upper panel comprises one or more inner tracks aligned with the one or more outer tracks, wherein one or more rollers are positioned between the one or more inner tracks and the one or more outer tracks.
